(19) United States
(12) Patent Application Publication
(10) Pub. No.: US 2026/0287350 A1
(43) Pub. Date: Sep. 24, 2026

(54) Rotary Laser with a Leveling Unit

(71) Applicant: Robert Bosch GmbH, Stuttgart (DE)

(72) Inventors: Ben William Carabelli, Leinfelden-Echterdingen (DE); Brooke Corbin, Chicago, IL (US); Christof Weitbrecht, Stuttgart (DE); Lalka Rasheva, Stuttgart (DE); Markus Hahl, Korntal-Muenchingen (DE)

(21) Appl. No.: 19/567,176

(22) Filed: Mar. 15, 2026

(30) Foreign Application Priority Data
Mar. 20, 2025 (DE) 10 2025 110 741.6

(51) Int. Cl. G01C 15/00; G01C 9/06

(52) U.S. Cl. CPC G01C 15/004; G01C 9/06; G01C 15/008

(57) ABSTRACT

A rotary laser includes a housing, in which a laser unit and a leveling unit are arranged, wherein the leveling unit comprises at least one tilt sensor for determining a respective orientation of an axis associated with the laser unit relative to the housing and at least one tilt adjustment unit for adjusting a specified target tilt of the associated axis relative to the housing. An operating unit is provided with an input unit and a display unit. The display unit is configured, in a first operating mode of the rotary laser, to visualize the specified target tilt of the associated axis in a first display mode, in particular in a first color.

This application claims priority under 35 U.S.C. § 119 to patent application no. DE 10 2025 110 741.6, filed on Mar. 20, 2025 in Germany, the disclosure of which is incorporated herein by reference in its entirety.

### BACKGROUND

The present disclosure relates to a rotary laser with a housing, in which a laser unit and a leveling unit are arranged, wherein the leveling unit comprises at least one tilt sensor for determining a respective orientation of an axis associated with the laser unit relative to the housing and at least one tilt adjustment unit for adjusting a specified target tilt of the associated axis relative to the housing, and wherein an operating unit is provided with an input unit and a display unit.

Such a rotary laser with a housing, in which a laser unit and a leveling unit are arranged, is known from prior art. The leveling unit comprises at least one tilt sensor for determining a respective orientation of an axis associated with the laser unit relative to the housing and at least one tilt adjustment unit for adjusting a specified target tilt of the associated axis relative to the housing. An operating unit with an input unit and a display unit is provided.

### SUMMARY

The disclosure relates to a rotary laser with a housing, in which a laser unit and a leveling unit are arranged, wherein the leveling unit comprises at least one tilt sensor for determining a respective orientation of an axis associated with the laser unit relative to the housing and at least one tilt adjustment unit for adjusting a specified target tilt of the associated axis relative to the housing, and wherein an operating unit is provided with an input unit and a display unit. The display unit is configured, in a first operating mode of the rotary laser, to visualize the specified target tilt of the associated axis in a first display mode, in particular in a first color.

The disclosure thus allows for the provision of a rotary laser, in which the first display mode allows simple and reliable visualization of the activated first operating mode.

Preferably, the display unit is configured, in a second and/or third operating mode of the rotary laser, to visualize a specified target tilt or a current tilt of the associated axis in a second display mode, in particular in a second color.

Thus, visualization in the second and third operating modes that is different from the first operating mode may be safely and reliably achieved.

Preferably, the first operating mode is a self-leveling mode, in which the specified target tilt corresponds to a tilt of the associated axis coinciding with a horizontal plane. Preferably, the second operating mode is a tilt adjustment mode, in which the specified target tilt corresponds to a tilt of the associated axis at a specified angle relative to a horizontal plane. Preferably, the third operating mode is a manual mode, in which the display unit indicates a current tilt of the associated axis relative to a horizontal plane.

Thus, in a simple manner, a corresponding tilt of the associated axis relative to a horizontal plane may be associated with each operating mode.

Preferably, in the manual mode, a user of the rotary laser manually operates the at least one tilt adjustment unit for orientation to a specified target tilt of the associated axis relative to the horizontal plane.

Thus, in the manual mode, orientation to a specified target tilt can be achieved in a simple and straightforward manner.

Preferably, a control and regulating unit is provided, which, in at least one operating mode, controls the at least one tilt adjustment unit such that a tilt of the associated axis determined by the at least one tilt sensor is oriented to coincide with a horizontal plane or a specified target tilt of the associated axis, wherein the display unit displays a blinking numerical value during the orientation, which value is associated with the horizontal plane or the specified target tilt.

Thus, an orientation process can be safely and reliably visualized.

Preferably, in at least one operating mode, the display unit permanently displays a numerical value associated with the target tilt if the tilt orientation of the associated axis is perfectly aligned with a horizontal plane and/or if the tilt orientation is perfectly aligned with the specified target tilt of the associated axis.

Thus, in a simple and uncomplicated manner, a visualization of a coincident alignment of the associated axis with the horizontal plane and/or the specified target tilt can be achieved.

The display unit is preferably configured as a segment display, wherein a separate segment is provided to visualize a numerical value in percent, an associated numerical value in degrees, and/or a sign of the displayed numerical value, associated with at least one operating mode.

Thus, an application-specific visualization of the numerical value can be achieved in a simple manner.

Preferably, the segment display is configured in two colors and/or the separate segment is configured in a single color or in two colors, or a backlight of the display unit is configured in two colors.

Thus, a colored display unit can be easily and straightforwardly provided.

Preferably, the display unit comprises a first region associated with a first tilt axis for displaying a first tilt of the associated axis along the first tilt axis and a second region associated with a second tilt axis for displaying a second tilt along the second tilt axis.

Thus, an efficient display unit may be provided for an accurate and precise display.

Moreover, the present disclosure relates to a method for indicating a tilt of an axis associated with the laser unit of the rotary laser described above relative to a housing of the rotary laser, comprising the steps of:
selecting the first, second or third operating mode,
setting a target tilt from a horizontal plane, or setting a current tilt of the associated axis relative to a horizontal plane, and
displaying the target tilt in the first operating mode by way of visualizing, in a first display mode, in particular a first color, or displaying the target tilt in the second operating mode in a second display mode, in particular a second color, or displaying the current tilt of the associated axis of the laser unit in the third operating mode in the second display mode, in particular the second color, in a display unit.
   The disclosure thus enables a method for displaying a tilt of an axis associated with a laser unit of a rotary laser relative to a horizontal plane, with which method a simple and reliable visualization of a determined tilt can be achieved with the first and second display modes.

Preferably, a numerical value associated with the current tilt or the specified target tilt is displayed in percent or in degrees.

A suitable display of the determined numerical value can thus be made in a simple manner.

Preferably, during an adjustment of the tilt adjustment unit to a horizontal plane or to the specified target tilt of the associated axis, the target tilt is displayed blinking on the display unit.

Thus, an orientation process can be safely and reliably visualized.

In at least one operating mode, a numerical value associated with the target tilt of the associated axis or the current tilt is preferably displayed up to a specified value with a delimiter to generate a decimal place, and, starting at a value greater than the specified value, the value is displayed with the delimiter deactivated.

Thus, an exact indication of the determined tilt can be provided in a simple and straightforward manner.

### BRIEF DESCRIPTION OF THE DRAWINGS

The disclosure is explained in more detail in the following description with reference to the exemplary embodiments shown in the drawings. They show:

FIG. 1 a perspective view of a rotary laser according to the present disclosure with a drive unit,

FIG. 2 a top view of a display unit of the rotary laser of FIG. 1 in a first operating mode with a first display mode,

FIG. 3 a top view of the display unit of the rotary laser of FIG. 2 in a second operating mode in a second display mode,

FIG. 4 a top view of the display unit of the rotary laser of FIG. 2 and FIG. 3 in a third operating mode in the second display mode,

FIG. 5 a top view of the display unit of the rotary laser of FIG. 4 at a comparatively large tilt,

FIG. 6 a top view of an alternative embodiment of the display unit of the rotary laser of FIG. 1,

FIG. 7 a top view of a further embodiment of the display unit of the rotary laser of FIG. 1, and

FIG. 8 a schematic diagram of a method for displaying a determined tilt in the display unit of FIG. 1 to FIG. 7.

### DETAILED DESCRIPTION

Elements with the same or a comparable function are provided with the same reference signs in the figures and are described in detail only once.

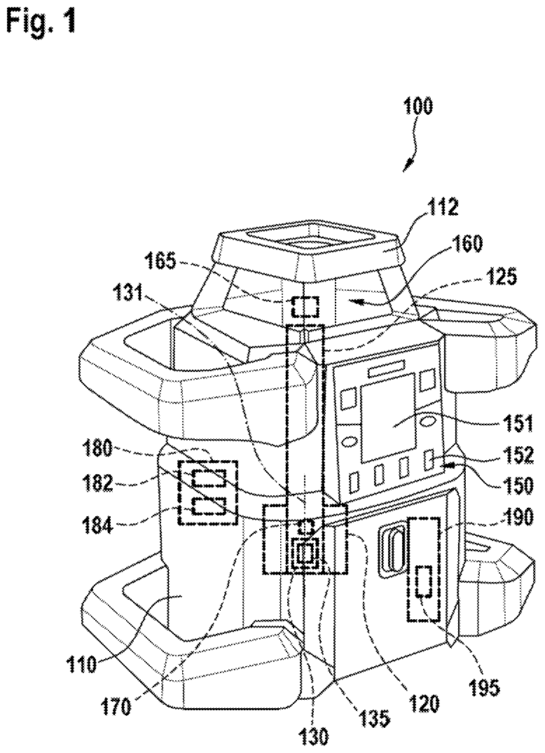

FIG. 1 illustrates an exemplary rotary laser 100 with a housing 110, in which a laser unit 130 with a laser diode 135 for generating a laser beam is arranged. A “rotary laser” may also be understood in the context of the present disclosure to mean a construction laser or a leveling laser. Furthermore, an example of a drive unit 120 for rotating a spindle 125 is arranged in the housing 110.

The laser unit 130 is illustratively arranged on the spindle 125 such that rotation of the spindle 125 rotates the laser beam generated by the laser unit 130 in an associated plane. To this end, the spindle 125 is preferably associated with a rotary head 160 with a beam diverter 165. The beam diverter 165 is preferably configured to deflect the laser beam, as a result of which the laser beam projects the associated plane. Depending on the design of the rotary laser 100, the projected plane may be horizontal, vertical, or, e.g., at a defined tilt angle with respect to the earth's surface. The drive unit 120 is preferably configured as an electric motor.

Moreover, an electronic unit 190 with a control and monitoring device 195 is preferably arranged in the housing 110. The control and monitoring device 195 is preferably configured to control the laser power of the laser unit 130 depending on a mode of operation. A rotational speed of the spindle 125 of the drive unit 120 is thus controlled or regulated. Preferably, a determination unit 170 is associated with the spindle 125 for this purpose.

According to one embodiment, the housing 110 is associated with a protective cage 112 associated with the rotary head 160 to protect against the rotary head 160 striking something.

The electronic unit 190 is preferably associated with an operating unit 150 with a display unit 151 configured as a display and an input unit 152. The operating unit 150 is preferably connected to the electronic unit 190, in particular to the control and monitoring device 195, for control or regulation. The input unit 152 comprises at least one keypad. Alternatively, it is also conceivable that the input unit 152 comprises a control dial, a touch screen, a slider, a remote control, or the like. For example, via the input unit 152, a user may enter a rotational speed for the spindle 125. Alternatively, the rotational speed of the laser unit 130 is automatically controllable in one mode of operation.

Preferably, the rotary laser 100 comprises a leveling unit 180. The leveling unit 180 preferably comprises at least one tilt sensor 184 configured to determine a tilt of the rotary head 160, in particular of the beam diverter 165, and/or of the laser unit 130 or of one of the axes 131 associated with the laser unit 130, relative to the vertical direction or to a horizontal plane. In this case, a tilt of the rotation head 160, in particular of the beam diverter 165 and/or of the laser unit 130 or of the axis 131 associated with the laser unit 130, is preferably determined relative to a specified, preferably horizontal direction or to a vertical. Moreover, the leveling unit 180 preferably comprises at least one tilt adjustment unit 182 configured to align the rotary head 160, in particular the beam diverter 165, and/or the laser unit 130 or the axis 131 of the laser unit 130, depending on a position determined by the at least one tilt sensor 184, preferably a tilt of the laser unit 130 or the axis 131 of the laser unit 130 and/or the rotary head 160, relative to the housing 110, preferably in the vertical direction. Preferably, the tilt adjustment unit 182 is configured as a tilt adjustment motor.

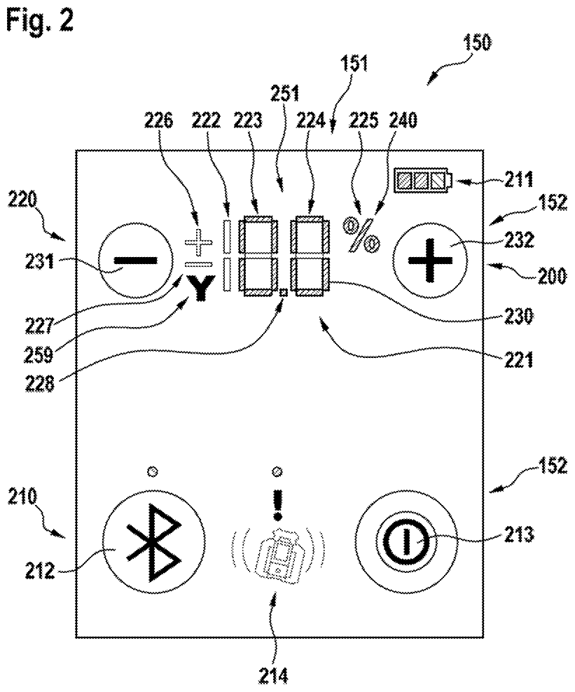

FIG. 2 shows the operating unit 150 of FIG. 1 with the display unit 151 and the input unit 152. The operating unit 150 preferably comprises a battery status indicator 211 that visualizes a battery status of the preferably battery-operated rotary laser 100 of FIG. 1. The battery status indicator 211 is arranged, by way of example, in a corner region, shown in the upper right in the illustration, of the operating unit 150. Furthermore, the operating unit 150 has an input area 210, shown at the bottom in the illustration. The input area 210 preferably includes an on/off switch 213 for turning on and turning off the rotary laser 100 of FIG. 1. Also, as seen in the illustration, the input area 210 comprises a Bluetooth activation control element 212 for activating a Bluetooth connection and/or for coupling to an external device via the Bluetooth connection. Moreover, the input area 210 comprises a display icon 214 that is activated or illuminated in the case of an error of the rotary laser 100 of FIG. 1. Furthermore, the operating unit 150 has a region 220, shown at the top in the illustration, for setting an operating mode of the rotary laser 100 of FIG. 1, as well as values associated with the operating mode.

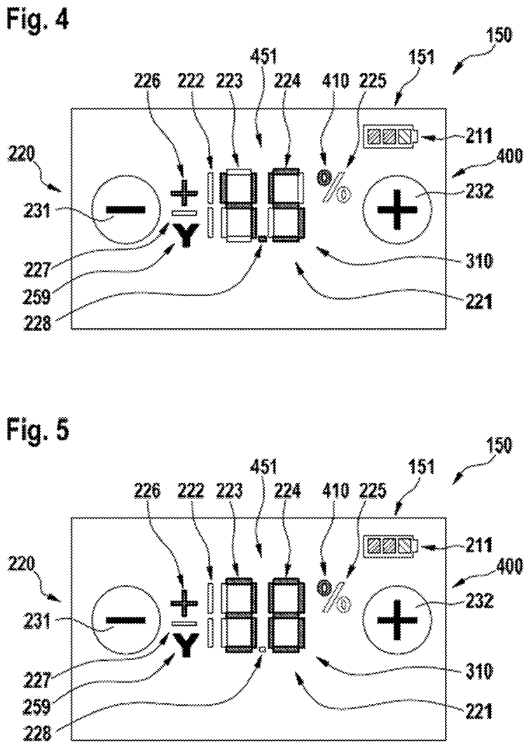

Preferably, the display unit 151 is configured as segment display 221. Preferably, the segment display 221 comprises three segments 222, 223, 224 and a delimiter 228 for visualizing a numerical value 251. Preferably, the display unit 151 displays the numerical value 251 (and 451 in FIG. 4) up to a specified value with a delimiter 228 to generate a decimal place, and starting at a value greater than the specified value, the display unit 151 displays the numerical value with a deactivated delimiter 228.

By way of example, the segment display 221 is configured as a 2.5-digit segment display. Preferably, the display unit 151 comprises a separate segment 225, 226, 227. A separate segment 225 is configured to visualize the numerical value 251 associated with at least one operating mode in percent 240 or degrees (410 in FIG. 4). Alternatively, a separate segment 225 may be present for display in percent and another separate segment 225 for a display in degrees. An additional separate segment 226 is configured to visualize a positive sign of the displayed numerical value 251, and a further additional separate segment 227 is configured to visualize a negative sign of the displayed numerical value 251. However, in contrast to segment 227, segment 226 is optional, so that in one variant segment 226 may also be omitted.

Preferably, the segment display 221 is configured in two colors. Preferably, at least the separate segment 225 and the delimiter 228 are configured in two colors. Alternatively or optionally, at least one, preferably all, separate or additional separate segments 225, 226, 227 are configured in one color or in two colors. Alternatively, or optionally, a backlight of the display unit 151 is configured in two colors. In this case, at least the segment display 221 or the segments 222, 223, 224, the delimiter 228 and/or the separate or additional separate segments 225, 226, 227 are equipped with a backlight. Preferably, a backlight associated with the separate and/or additional separate segments 225, 226, 227 is configured in one color.

Furthermore, the region 220 illustratively comprises two control elements 231, 232 for setting a target tilt value and/or for selecting and activating an operating mode. A control element 231 is arranged to the left of the segment display 221 for illustrative purposes, and a control element 232 is arranged to the right of the segment display 221 for illustrative purposes.

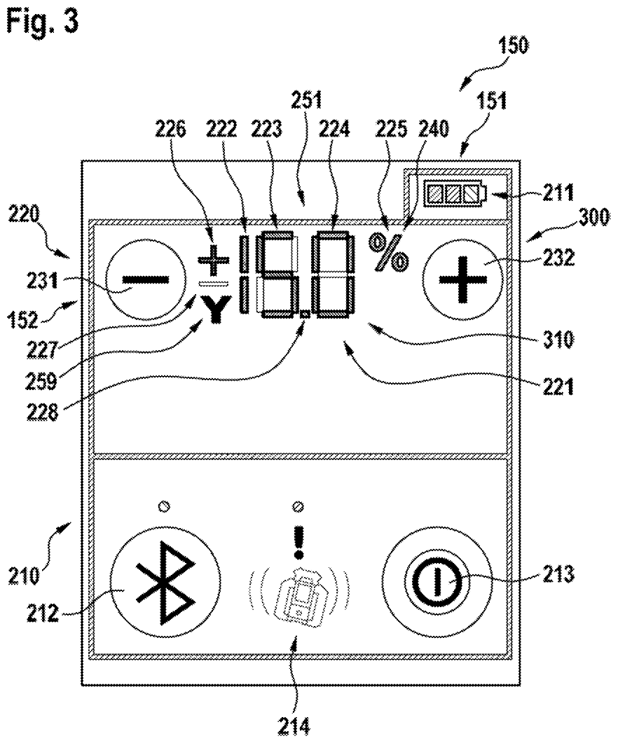

Preferably, the display unit 151 is configured to visualize, in a first operating mode 200 of the rotary laser 100 of FIG. 1, a specified target tilt of the axis 131 of FIG. 1 of the laser unit 130 of FIG. 1 in a first display mode 230, particularly in a first color. Furthermore, in a second and/or third operating mode (300 in FIG. 3; 400 in FIG. 4) of the rotary laser 100 of FIG. 1, the display unit 151 is configured to visualize a specified target tilt or current tilt of the axis 131 of FIG. 1 of the laser unit 130 of FIG. 1 in a second display mode (310 in FIG. 3), in particular in a second color. Preferably, the first and second display modes 230 (and 310 in FIG. 3), and the first and second colors, are different. The first and second display modes 230 (and 310 in FIG. 3), and the first and second colors, respectively, are essentially used to clearly identify the first operating mode 200.

Preferably, the first color is green, and the second color is red. It is noted, however, that the present disclosure is not limited to a first color in green and a second color in red. Thus, the first and second color may be selected as desired.

Preferably, the first operating mode 200 is a self-leveling mode, in which the specified target tilt corresponds to a tilt of the axis 131 of FIG. 1 of the laser unit 130 of FIG. 1 coinciding with a horizontal plane. The second operating mode (300 in FIG. 3) is preferably a tilt adjustment mode, in which the specified target tilt corresponds to a tilt of the axis 131 of FIG. 1 of the laser unit 130 of FIG. 1 at a specified angle relative to a horizontal plane. Preferably, the third operating mode (400 in FIG. 4) is a manual mode, in which the display unit 151 indicates a current tilt of the axis 131 of FIG. 1 of the laser unit 130 of FIG. 1 relative to a horizontal plane. In manual mode, a user of the rotary laser 100 of FIG. 1 preferably manually operates the at least one tilt adjustment unit 182 of FIG. 1 to orient the axis 131 of FIG. 1 of the laser unit 130 of FIG. 1 to the target tilt.

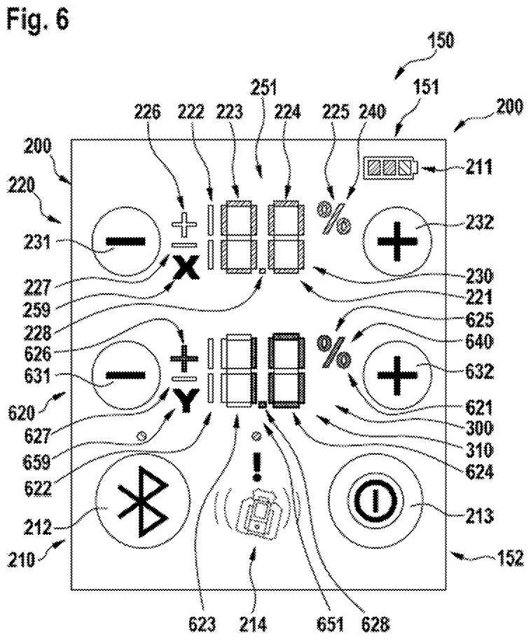

Preferably, the display unit 151 visualizes the numerical value 251 (and 451 in FIG. 4) associated with an operating mode in percent 240 (and 640 in FIG. 6) or degrees (410 in FIG. 4). For example, the display unit 151 visualizes a numerical value 251 associated with the first and second operating modes 200 (and 300 in FIG. 3) in percent 240 (and 640 in FIG. 6) and a numerical value (451 in FIG. 4) associated with the third operating mode (400 in FIG. 4) in degrees (410 in FIG. 4). Preferably, in the second operating mode (300 in FIG. 3), or the tilt adjustment mode, the specified or set target tilt with sign is displayed by way of the additional separate segments 226, 227 and with the separate segment 225 in the percent unit 240 (and 640 in FIG. 6). In the third operating mode (400 in FIG. 4), or the manual mode, preferably, the tilt measured by the at least one tilt sensor 184 of FIG. 1, or the current tilt with sign, is displayed by the additional separate segments 226, 227 with the separate segment 225 in the degree unit (410 in FIG. 4).

Preferably, in at least one operating mode, the control and regulating unit 195 of FIG. 1 controls the at least one tilt adjustment unit 182 of FIG. 1 such that the tilt of the axis 131 of FIG. 1 of the laser unit 130 of FIG. 1 determined by the at least one tilt sensor 184 of FIG. 1 is oriented to coincide with the horizontal plane or with a specified target tilt of the axis 131 of FIG. 1 of the laser unit 130 of FIG. 1. During an orientation of the laser unit 130 of FIG. 1 by the tilt adjustment unit 182 of FIG. 1, the display unit 151 blinks. More particularly, in the first operating mode 200, or the self-leveling mode, the control and regulating unit 195 of FIG. 1 preferably controls the at least one tilt adjustment unit 182 of FIG. 1 such that the tilt of the axis 131 of the laser unit 130 of FIG. 1 determined by the at least one tilt sensor 184 of FIG. 1 is oriented to coincide with the horizontal plane. Furthermore, in the second operating mode (300 in FIG. 3), or the tilt adjustment mode, the control and regulating unit 195 of FIG. 1 preferably controls the at least one tilt adjustment unit 182 of FIG. 1 such that the tilt of the axis 131 of FIG. 1 of the laser unit 130 of FIG. 1 determined by the at least one tilt sensor 184 of FIG. 1 is oriented to coincide with a specified target tilt of the axis 131 of FIG. 1 of the laser unit 130 of FIG. 1.

Preferably, in at least one operating mode, the display unit 151 permanently displays a numerical value 251 (and 451 in FIG. 4) associated with the tilt if the tilt orientation of the axis 131 of FIG. 1 of the laser unit 130 of FIG. 1 is perfectly aligned with the horizontal plane and/or if the tilt orientation is perfectly aligned with the specified target tilt of the axis 131 of FIG. 1 of the laser unit 130 of FIG. 1. Preferably, upon achieving a desired orientation of the laser unit 130 or the axis 131 of FIG. 1 of the laser unit 130 of FIG. 1 by way of the tilt adjustment unit 182 of FIG. 1, the orientation stops, and the numerical value 251, which blinks when during orientation of the axis 131 of FIG. 1 of the laser unit 130 of FIG. 1, no longer blinks and is illuminated permanently or constantly. Preferably, in the first operating mode 200, or the self-leveling mode, when tilt orientation of the axis 131 of FIG. 1 of the laser unit 130 of FIG. 1 is perfectly aligned with the horizontal axis, the numerical value 251 associated with the target tilt is permanently illuminated. Alternatively or optionally, in the second operating mode (300 in FIG. 3), or the tilt adjustment mode, when the tilt orientation is perfectly aligned with the specified target tilt of the axis 131 of FIG. 1 of the laser unit 130 of FIG. 1, the numerical value 251 associated with the specified target tilt is permanently illuminated. Alternatively or optionally, in the third operating mode (400 in FIG. 4), a numerical value (451 in FIG. 4) associated with the current tilt is always permanently illuminated.

Preferably, the display unit 151 comprises the first region 220 associated with a first tilt axis 259 for displaying a first tilt of the axis 131 of FIG. 1 of the laser unit 130 of FIG. 1 along the first tilt axis 259 and/or a second region (620 in FIG. 6) associated with a second tilt axis (659 in FIG. 6) for displaying a second tilt along the second tilt axis (659 in FIG. 6). By way of example, the first tilt axis 259 is visualized in FIG. 2 with a “Y”. Alternatively, the first tilt axis 259 may be visualized with an “X”, as shown by way of example in FIG. 6. The two tilt axes 259 (and 659 in FIG. 6) may be operated independently of each other in different operating modes, which may cause the display mode in the two regions 220 (and 620 in FIG. 6) to differ from one another.

By way of illustration, in FIG. 2, the first operating mode 200, or the self-leveling mode, is activated. Preferably, the first operating mode 200, or the self-leveling mode, is indicated by the first display mode, preferably in the first color 230. Furthermore, the numerical value 251 associated with the target tilt is displayed as “0.0%”, wherein blinking of the segment display 221 indicates that an orientation of the laser unit 130 of FIG. 1 by the leveling unit 180 of FIG. 1, or a leveling, is still in progress and the target tilt has not yet been achieved. Preferably, during leveling, the laser unit 130 of FIG. 1, or the laser diode 135 of FIG. 1, also remains off. The laser diode 135 of FIG. 1 does not turn on until the target tilt has been achieved to an allowable tolerance. Since the first operating mode 200 is particularly critical for a user of the rotary laser 100 of FIG. 1, because the first operating mode is primarily used for large-area work such as concrete casting operations, and high consequential costs can be incurred in the case of an accidental or erroneous tilt adjustment.

FIG. 3 shows the operating unit 150 with the display unit 151 and the input unit 152 of FIG. 2 in a second operating mode 300, or in a tilt adjustment mode. In the second operating mode 300, or the tilt adjustment mode, the displayed numerical value 251 corresponds to the target tilt specified or set by a user of the rotary laser 100 of FIG. 1. The target tilt is indicated with a sign by way of the additional separate segments 226, 227, preferably with the unit percent 240 (and 640 in FIG. 6), as shown in FIG. 3.

In FIG. 3, the numerical value 251 of the specified target tilt associated with the second operating mode 300 is, by way of example, “+15.0%” and is shown in a second display mode 310, or in the second color. Blinking of the segment display 221, indicates that an orientation of the laser unit 130 of FIG. 1 by the leveling unit 180 of FIG. 1 is still in progress and the target tilt has not yet been achieved. When the target tilt is achieved, the segment display 221 is permanently or constantly illuminated.

FIG. 4 shows the region 220 of the operating unit 150 with the display unit 151 of FIG. 2 and FIG. 3 in a third operating mode 400, or in a manual mode. In the third operating mode 400, or the manual mode, a displayed numerical value 451 corresponds to a current tilt measured by the at least one tilt sensor 184 of FIG. 1. The current tilt is indicated with a sign by way of the additional separate segments 226, 227 and in the separate segment 225 with the unit degree 410, as shown in FIG. 4. In FIG. 4, the numerical value 451 associated with the third operating mode 400 is, by way of example, “+4.5°” and is shown in the second display mode 310, or in the second color.

FIG. 5 shows the region 220 of the operating unit 150 with the display unit 151 of FIG. 2 to FIG. 4 in the third operating mode 400, or in a manual mode. In manual mode, the segment display 221 is permanently or constantly illuminated. As described above, the display unit 151 displays the numerical value 451 up to a specified value with a delimiter 228 to generate a decimal place, and starting at a value greater than the specified value, the display unit 151 displays the numerical value 451 with the delimiter 228 deactivated. Preferably, the specified value is 19.9 such that, at a numerical value 451 below 19.9, the delimiter 228 is activated and, at a numerical value 451 above 19.9, it is deactivated. For example, the numerical value 451 “+1.9°” is displayed with delimiter 228, and the numerical value 451 “−34 °” is displayed without delimiter 228. In FIG. 5, the displayed numerical value 451 is “+38°” and is above the specified value 19.9. Therefore, the delimiter 228 is deactivated.

FIG. 6 shows the operating unit 150 with the display unit 151 and the input unit 152 from FIG. 2 to FIG. 5 including the region 220 from FIG. 2 to FIG. 5 and another region 620, shown at the bottom in the illustration. As described above, the region 220 is associated with a first tilt axis 259 and is configured to display a first tilt of the axis 131 of FIG. 1 of the laser unit 130 of FIG. 1 along the first tilt axis 259. The region 620 is associated with a second tilt axis 659, by way of example, and is configured to display a second tilt along the second tilt axis 659. By way of example, the first tilt axis 259 is visualized with an “X” in FIG. 6 and the second tilt axis 659 is visualized with a “Y”. The two regions 220, 620 are preferably independent of each other.

Preferably, the display unit 151 comprises the segment display 221 associated with the region 220 and a segment display 621 associated with the region 620. The segment display 621 is preferably identical to the segment display 221. Preferably, the segment display 621 comprises three segments 622, 623, 624 and a delimiter 628 for visualizing a numerical value 651.

Analogously to the segment display 221, the segment display 621 is configured as a 2.5 digit segment display. Preferably, the display unit 151 comprises separate segments 625, 626, 627 associated with the region 620. The separate segment 625 is configured to visualize a numerical value 651 associated with at least one operating mode in percent 640 or degrees 410 in FIG. 4. The separate segment 626 may be optional and, for illustrative purposes, is configured to visualize a positive sign of the displayed numerical value 651, and the separate segment 627 is configured to visualize a negative sign of the displayed numerical value 651.

Preferably, the segment display 621 is configured in two colors. Alternatively or optionally, at least one, and preferably all, of the separate segments 625, 626, 627 are configured in one color or in two colors. Alternatively, or optionally, a backlight of the display unit 151 is configured in two colors.

Furthermore, by way of illustration, the region 620 comprises two control elements 631, 632 for setting a target tilt value. A control element 631 is arranged to the left of the segment display 621 for illustrative purposes, and a control element 632 is arranged to the right of the segment display 621 for illustrative purposes.

By way of illustration, the region 220 is in the first operating mode 200, wherein the segment display 221 visualizes the numerical value 251 “0.0%” in the first display mode 230, or in the first color. The region 620 visualizes a target tilt “+1.0%” associated with the second operating mode 300 in the second display mode 310, or in the second color. Alternatively, the region 620 may visualize a current tilt “+1.0°” associated with the third operating mode 400 in the second display mode 310, or in the second color.

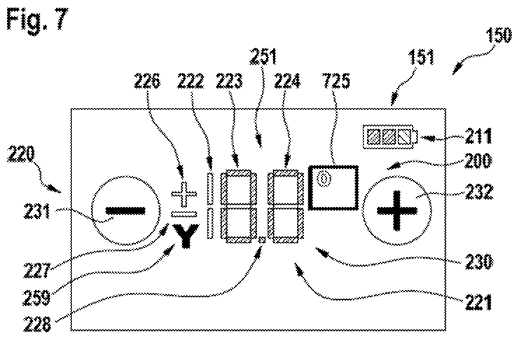

FIG. 7 shows the region 220 of the operating unit 150 with the display unit 151 of FIG. 2 to FIG. 6 in the first operating mode 200. By way of example, the segment display 221 comprises an alternative separate segment 725, which is preferably configured in only a single color, in comparison to the separate segment 225 from FIG. 2 to FIG. 6, which is preferably configured in two colors. The segment 725 is preferably activated at least in one operating mode 200, 300 of FIGS. 3, 400 of FIG. 4. In the activated state, the segment 725 illuminates in the first or second display mode. In FIG. 7, by way of example, the segment 725 is deactivated in the first and second operating modes 200, 300 of FIG. 3 and only activated in the third operating mode 400 of FIG. 4, wherein the segment 725 preferably illuminates in the second display mode 310, or in the second color. The segment 725, by way of example, visualizes the degree unit 410 of FIG. 4.

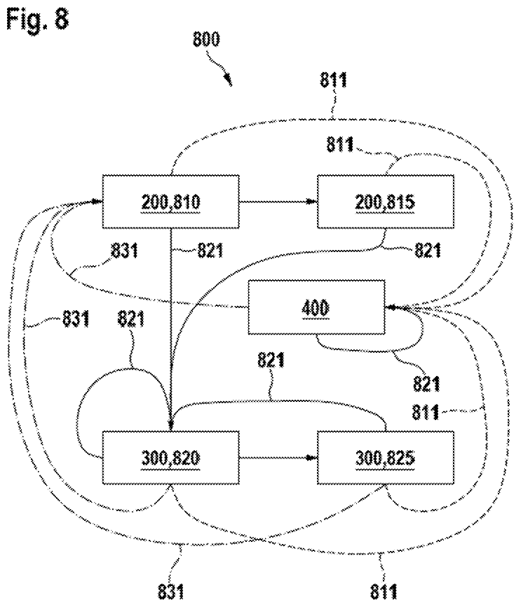

FIG. 8 illustrates an exemplary method 800 for operating the rotary laser 100 of FIG. 1. In particular, the method is designed to display a tilt of the axis 131 of the laser unit 130 of the rotary laser 100 of FIG. 1 relative to the vertical or to a horizontal plane.

In the first operating mode 200 of FIG. 2, FIG. 6 and FIG. 7, or the self-leveling mode, as described above, preferably the target tilt “0.0%” is always displayed in the first display mode 230 of FIG. 2, FIG. 6 and FIG. 7, or in the first color. Preferably, the target tilt is displayed in percent 240 of FIG. 2, FIG. 3, and FIG. 6. During an orientation process 810, i.e., at a tilt unequal to the target tilt “0.0%”, the segment display 221 of FIG. 2 to FIG. 7, or the target tilt “0.0%” displayed in the segment display 221 of FIG. 2 to FIG. 7, will blink. When the orientation process 810 is finished, i.e., a target state 815 at which the target tilt “0.0%” is set is achieved, the segment display 221 of FIG. 2 to FIG. 7, or the target tilt “0.0%”, is constantly illuminated in the first display mode 230 of FIG. 2, FIG. 6 and FIG. 7, or in the first color.

In the second operating mode 300 of FIG. 3 and FIG. 6, or the tilt adjustment mode, as described above, preferably the target tilt set by a user of the rotary laser 100 of FIG. 1 is always displayed in the second display mode 310 of FIG. 3 to FIG. 6, or in the second color. The target tilt can be input by operating the control elements 231, 232, in particular it can be reduced or increased incrementally. Alternatively, the target tilt can be specified, e.g., via a Bluetooth connection (smartphone app, remote control, etc.). Preferably, the target tilt is displayed in percent 240 of FIG. 2, FIG. 3, and FIG. 6. During an orientation process 820, i.e., at a tilt unequal to the set target tilt, the segment display 221 of FIG. 2 to FIG. 7, or the target tilt displayed in the segment display 221 of FIG. 2 to FIG. 7, will blink. When the orientation process 820 is finished, i.e., a target state 825 at which the set target tilt is achieved, the segment display 221 of FIG. 2 to FIG. 7, or the target tilt, is constantly illuminated in the second display mode 310 of FIG. 3 to FIG. 6, or in the second color.

In the third operating mode 400 of FIG. 4 and FIG. 5, or in the manual mode, as described above, preferably the current tilt, which is set by a user of the rotary laser 100 of FIG. 1, is always displayed in the second display mode 310 of FIG. 3 to FIG. 6, or in the second color. Preferably, the current tilt is indicated in degrees 410 of FIG. 4 and FIG. 5. The current tilt is directly altered by operating the control elements 231, 232 of FIG. 2 to FIG. 7 by a user of the rotary laser 100 of FIG. 1, i.e., the tilt adjustment unit 182 of FIG. 1 is controlled directly by the control and regulating unit 195 of FIG. 1 to adjust the tilt. The segment display 221 of FIG. 2 to FIG. 7 illuminates continuously in the third operating mode 400 of FIG. 4 and FIG. 5, or the manual mode, in the second display mode 310 of FIG. 3 to FIG. 6, or in the second color.

A first input 831 in the second operating mode 300 of FIG. 3, and/or in the third operating mode 400 of FIG. 4 and FIG. 5, activates the first operating mode 200 of FIG. 2, FIG. 6 and FIG. 7. Preferably, the first input 831 is a comparatively short and simultaneous pressing of the two control elements 231, 232 of FIG. 2 to FIG. 7.

A second input 821 in the first operating mode 200 of FIG. 2, FIG. 6, and FIG. 7, and/or in the third operating mode 400 of FIG. 4 and FIG. 5, activates the second operating mode 300 of FIG. 3 and FIG. 6. Preferably, the second input 821 is pressing one of the control elements 231, 232 of FIG. 2 to FIG. 7 to adjust the target tilt.

A third input 811 in the first operating mode 200 of FIG. 2, FIG. 6, and FIG. 7, and/or in the second operating mode 300 of FIG. 3 and FIG. 6, activates the third operating mode 400 of FIG. 4 and FIG. 5. Preferably, the third input 811 is a comparatively long and simultaneous pressing of the two control elements 231, 232 of FIG. 2 to FIG. 7.

What is claimed is:

1. A rotary laser; comprising:
a housing;
a laser unit arranged in the housing;
a leveling unit arranged in the housing, wherein the leveling unit includes (i) at least one tilt sensor configured to determine a respective orientation of an axis associated with the laser unit relative to the housing, and (ii) at least one tilt adjustment unit configured to adjust a specified target tilt of the associated axis relative to the housing; and
an operating unit including an input unit and a display unit, wherein the display unit is configured, in a first operating mode of the rotary laser, to visualize a specified target tilt of an associated axis in a first display mode.

2. The rotary laser according to claim 1, wherein the display unit is configured, in a second and/or third operating mode of the rotary laser, to visualize the specified target tilt or the current tilt of the associated axis in a second display mode.

3. The rotary laser according to claim 1, wherein the first operating mode is a self-leveling mode, in which the specified target tilt corresponds to a tilt of the associated axis coinciding with a horizontal plane.

4. The rotary laser according to claim 3, wherein the second operating mode is a tilt adjustment mode, in which the specified target tilt corresponds to a tilt of the associated axis at a specified angle relative to a horizontal plane.

5. The rotary laser according to claim 4, wherein the third operating mode is a manual mode, in which the display unit indicates a current tilt of the associated axis relative to a horizontal plane.

6. The rotary laser according to claim 5, wherein:
in the manual mode, a user of the rotary laser manually operates the at least one tilt adjustment unit for orientation to a specified target tilt of the associated axis relative to the horizontal plane.

7. The rotary laser according to claim 1, further comprising:
a control and regulating unit, which, in at least one operating mode, is configured to control the at least one tilt adjustment unit such that a tilt of the associated axis determined by the at least one tilt sensor is oriented to coincide with a horizontal plane or a specified target tilt of the associated axis, wherein the display unit is configured to display a blinking numerical value during the orientation, which value is associated with the horizontal plane or with the specified target tilt.

8. The rotary laser according to claim 1, wherein the display unit, in at least one operating mode, permanently displays a numerical value associated with the target tilt if the tilt orientation of the associated axis is perfectly aligned with a horizontal plane and/or if the tilt orientation is perfectly aligned with the specified target tilt of the associated axis.

9. The rotary laser according to claim 1, wherein the display unit is configured as a segment display, and wherein a separate segment is provided for visualizing a numerical value associated with at least one operating mode in percent, an associated numerical value in degrees, and/or a sign of the displayed numerical value.

10. The rotary laser according to claim 9, wherein the segment display is configured in two colors and/or the separate segment is configured in a single color or in two colors, or a backlight of the display unit is configured in two colors.

11. The rotary laser according to claim 1, wherein the display unit includes a first region associated with a first tilt axis for displaying a first tilt of the associated axis along the first tilt axis and a second region associated with a second tilt axis for displaying a second tilt along the second tilt axis.

12. A method for indicating a tilt of an axis associated with the laser unit relative to the housing of the rotary laser according to claim 1, the method comprising:
selecting the first, second, or third operating mode;
setting a target tilt relative to a horizontal plane, or setting a current tilt of the associated axis of the laser unit relative to a horizontal plane; and
displaying the target tilt in the first operating mode by way of visualizing, in a first display mode, or displaying the target tilt in the second operating mode in a second display mode, or displaying the current tilt of the associated axis in the third operating mode in the second display mode in a display unit.

13. The method according claim 12, wherein a numerical value associated with the current tilt or specified target tilt is displayed in percent or in degrees.

14. The method according to claim 12, wherein:
during an adjustment of the tilt adjustment unit to a horizontal plane or to the specified target tilt of the associated axis, the target tilt is displayed blinking on the display unit.

15. The method according to claim 12, wherein:
in at least one operating mode, a numerical value associated with the target tilt of the associated axis or with the current tilt is displayed up to a specified value with a delimiter to generate a decimal place, and starting at a value greater than the specified value, the value is displayed with the delimiter deactivated.

16. The rotary laser according to claim 1, wherein the first display mode is a first color.

17. The rotary laser according to claim 2, wherein:
the first display mode is a first color, and
the second display mode is a second color.

18. The method according claim 12, wherein:
the first display mode is a first color, and
the second display mode is a second color.
